(19) United States
(12) Patent Application Publication
(10) Pub. No.: US 2018/0314756 A1
(43) Pub. Date: Nov. 1, 2018

(54) ONLINE SOCIAL NETWORK MEMBER PROFILE TAXONOMY

(71) Applicant: Linkedln Corporation, Sunnyvale, CA (US)

(72) Inventors: Qin Iris Wang, Cupertino, CA (US); Feng Guo, Los Gatos, CA (US); Qi He, San Jose, CA (US)

(21) Appl. No.: 15/497,572

(22) Filed: Apr. 26, 2017

(51) Int. Cl. G06F 17/30; G06Q 50/00

(52) U.S. Cl. CPC G06F 17/30705; G06F 17/30631; G06F 17/30675; G06F 17/30958; G06Q 50/01; G06F 17/30241; G06F 17/30702

(57) ABSTRACT

Among other things, embodiments of the present disclosure discussed herein may be used to analyze the online social network profiles of members of the social network and identify new content items. The system can also identify similarities between newly-identified content items and existing content items in member profiles to alert members to the new content items for possible inclusion in their profiles.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright LinkedIn, All Rights Reserved.

### BACKGROUND

As the popularity of online, Internet-based social networks continues to grow, there is an increasing need for content hosts and providers (as well as others) to efficiently and effectively present the information contained in the profiles of social network members (also referred to herein as social network users). Among other things, embodiments of the present disclosure help identify new content items within online social network profiles and alert members of the new content items for possible inclusion in their profiles.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram illustrating a client-server system, according to various exemplary embodiments;

FIG. 2 is a flow diagram of a method according to various exemplary embodiments.

FIG. 3 is a block diagram illustrating an exemplary mobile device.

FIG. 4 is a block diagram illustrating components of an exemplary computer system.

### DETAILED DESCRIPTION

In the following, a detailed description of examples will be given with references to the drawings. It should be understood that various modifications to the examples may be made. In particular, elements of one example may be combined and used in other examples to form new examples. Many of the examples described herein are provided in the context of a social or business networking website or service. However, the applicability of the embodiments in the present disclosure are not limited to a social or business networking service.

Among other things, embodiments of the present disclosure discussed herein may be used to analyze the online social network profiles of members of the social network and identify new content items. The system can also identify similarities between newly-identified content items and existing content items in member profiles to alert members to the new content items for possible inclusion in their profiles.

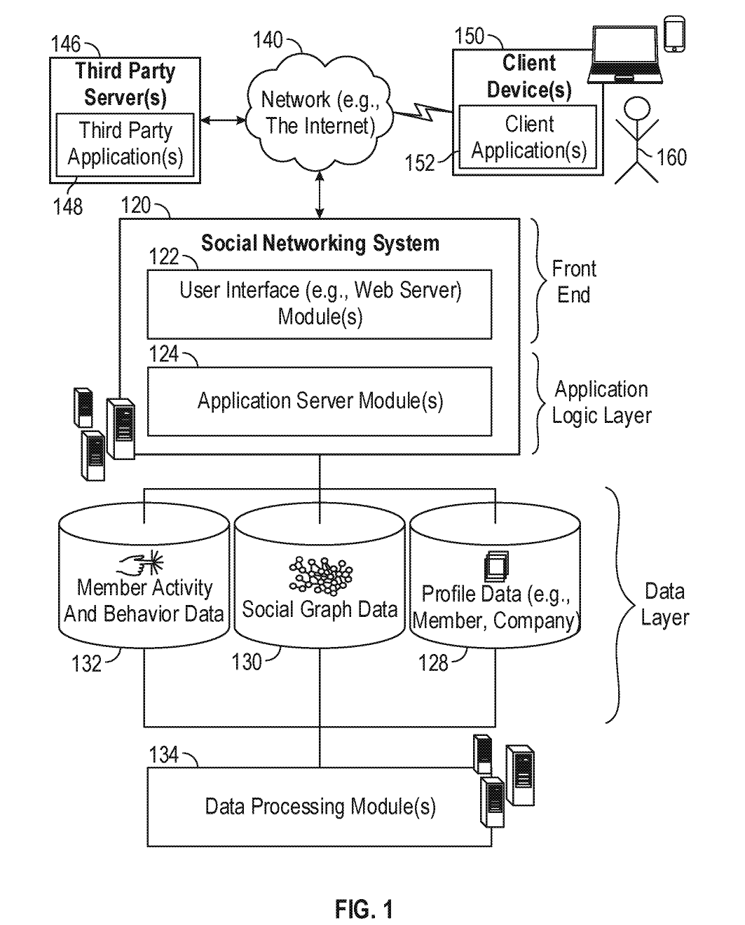

FIG. 1 illustrates an exemplary client-server system that may be used in conjunction with various embodiments of the present disclosure. The social networking system 120 may be based on a three-tiered architecture, including (for example) a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. Various additional functional modules and engines may be used with the social networking system illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the embodiments of the present disclosure are not limited to such architecture.

An Internet-based social networking service is a web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information.

For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes may be referred to as “business networks” or “professional networks”).

Online social network platforms (also referred to herein as Internet-based social networks) provide a variety of information and content to users of the social network, such as articles on various topics, updates related to a user and individuals within the user's network, job opportunities, friend (or connection) suggestions, advertisements, news stories, and the like.

As shown in FIG. 1, the front end layer consists of a user interface module(s) (e.g., a web server) 122, which receives content requests from various computing devices including one or more user computing device(s) 150, and communicates appropriate responses to the requesting device. For example, the user interface module(s) 122 may receive requests in the form of Hypertext Transport Protocol (HTTP) requests, or other web-based, application programming interface (API) requests. The user device(s) 150 may be executing conventional web browser applications and/or applications (also referred to as “apps”) that have been developed for a specific platform to include any of a wide variety of mobile computing devices and mobile-specific operating systems.

For example, user device(s) 150 may be executing user application(s) 152. The user application(s) 152 may provide functionality to present information to the user and communicate via the network 140 to exchange information with the social networking system 120. Each of the user devices 150 may comprise a computing device that includes at least a display and communication capabilities with the network 140 to access the social networking system 120. The user devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other entity interacting with the client device(s) 150. The user(s) 160 may interact with the social networking system 120 via the user device(s) 150. The user(s) 160 may not necessarily be part of the networked environment, but may be associated with user device(s) 150.

For example, the user 160 may, using the user's client device 150, submit a request for web page content (e.g., by entering or selecting a web page address via a web browser) hosted by a third party server 146 and/or social networking system 120. The server 146 and/or social networking system 120 may, in response to the request, cause web page content to display on a display screen coupled to the client device 150, and to classify the web content as described in more detail below.

As shown in FIG. 1, the data layer includes several databases, including a database 128 for storing data for various entities of a social graph. In some exemplary embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. With various alternative embodiments, any number of other entities may be included in the social graph, and as such, various other databases may be used to store data corresponding to other entities. For example, the data layer may include one or more databases for storing webpage metadata.

In some embodiments, when a user initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some exemplary embodiments, members may receive advertising targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124.

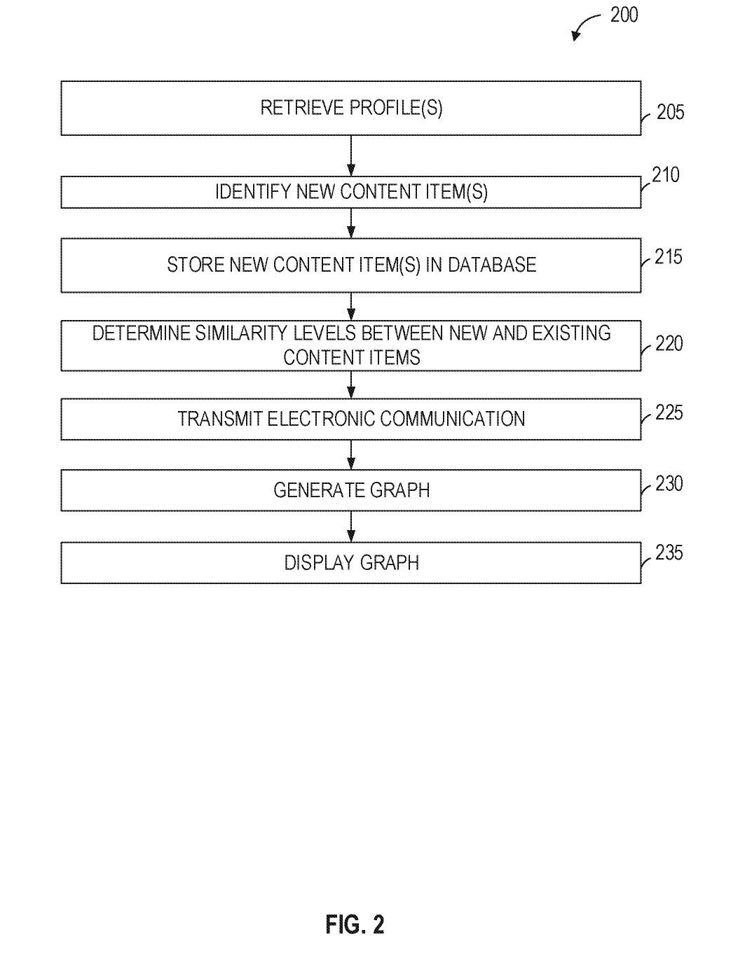

Further, as shown in FIG. 1, a data processing module 134 may be used with a variety of applications, services, and features of the social networking system 120. The data processing module 134 may periodically access one or more of the databases 128, 130, and/or 132, process (e.g., execute batch process jobs to analyze or mine) profile data, social graph data, member activity and behavior data, and generate analysis results based on the analysis of the respective data. The data processing module 134 may operate offline. According to some exemplary embodiments, the data processing module 134 operates as part of the social networking system 120. Consistent with other exemplary embodiments, the data processing module 134 operates in a separate system external to the social networking system 120. In some exemplary embodiments, the data processing module 134 may include multiple servers of a large-scale distributed storage and processing framework, such as Hadoop servers, for processing large data sets. The data processing module 134 may process data in real time, according to a schedule, automatically, or on demand. In some embodiments, the data processing module 134 may perform (alone or in conjunction with other components or systems) the functionality of method 200 depicted in FIG. 2 and described in more detail below.

Additionally, a third party application(s) 148, executing on a third party server(s) 146, is shown as being communicatively coupled to the social networking system 120 and the user device(s) 150. The third party server(s) 146 may support one or more features or functions on a website hosted by the third party.

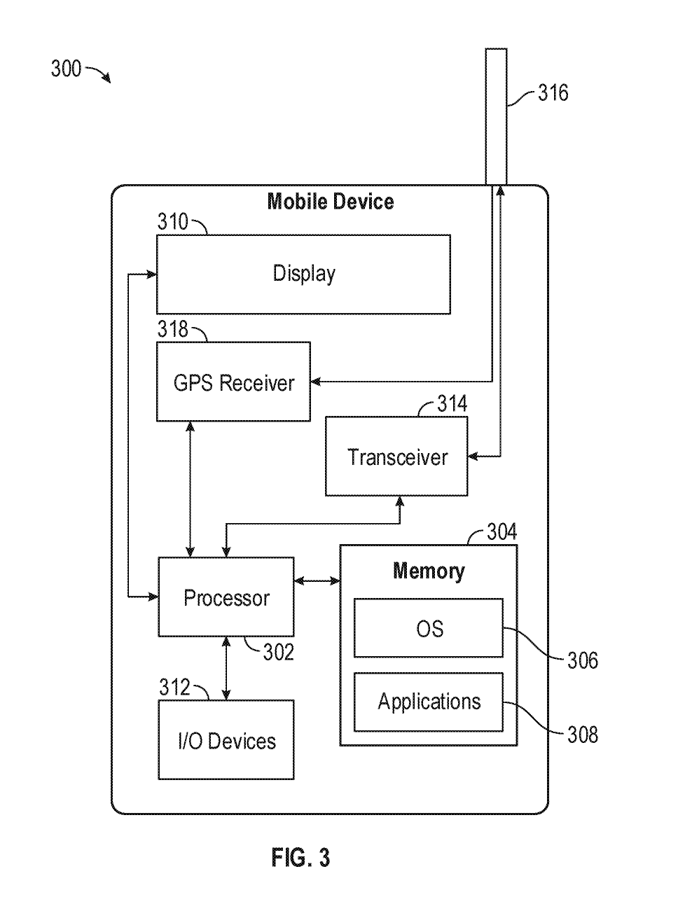

FIG. 2 illustrates an exemplary method 200 according to various aspects of the present disclosure. Embodiments of the present disclosure may practice the steps of method 200 in whole or in part, and in conjunction with any other desired systems and methods. The functionality of method 200 may be performed, for example, using any combination of the systems depicted in FIGS. 1, 3, and/or 4.

In this example, method 200 includes retrieving one or more online social network profiles for one or more members (205), analyzing content in the online social network profile(s) to identify one or more new content items (210), storing the new content item in a database (215) determining levels of similarity between a new content item and existing content items in one or more member profiles (220), transmitting an electronic communication to a computing device of a member (225), and generating (230) and displaying (235) a graph indicating the relationship between content items.

An online social network is a type of networked service provided by one or more computer systems accessible over a network that allows users/members of the service to build or reflect social networks or social relations among members. Members may be individuals or organizations. Typically, members construct profiles, which may include personal information such as the member's name, contact information, employment information, photographs, personal messages, status information, multimedia, links to web-related content, blogs, and so on. In order to build or reflect the social networks or social relations among members, the social networking service allows members to identify, and establish links or connections with other members. For instance, in the context of a business networking service (a type of social networking service), a member may establish a link or connection with his or her business contacts, including work colleagues, clients, customers, personal contacts, and so on. With a social networking service, a member may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and a social networking service may likewise be used for business networking purposes as well as or in place of social networking purposes. A connection may be formed using an invitation process in which one member “invites” a second member to form a link. The second member then has the option of accepting or declining the invitation.

In general, a connection or link represents or otherwise corresponds to an information access privilege, such that a first member who has established a connection with a second member is, via the establishment of that connection, authorizing the second member to view or access certain non-publicly available portions of their profiles that may include communications they have authored. Example communications may include blog posts, messages, “wall” postings, or the like. Of course, depending on the particular implementation of the business/social networking service, the nature and type of the information that may be shared, as well as the granularity with which the access privileges may be defined to protect certain types of data may vary.

Some social networking services may offer a subscription or “following” process to create a connection instead of, or in addition to the invitation process. A subscription or following model is where one member “follows” another member without the need for mutual agreement. Typically in this model, the follower is notified of public messages and other communications posted by the member that is followed. An example social networking service that follows this model is Twitter®—a micro-blogging service that allows members to follow other members without explicit permission. Other connection-based social networking services also may allow following-type relationships as well. For example, the social networking service LinkedIn® allows members to follow particular companies.

As part of their member profiles, members may include information on their current position of employment. Information on their current position includes their title, company, geographic location, industry, and periods of employment. The social networking service may also track skills that members possess and when they learned those skills. Skills may be automatically determined by the social networking service based upon member profile attributes of the member, or may be manually entered by the member.

Embodiments of the present disclosure may apply machine learning and natural language processing algorithms to identify new content items (also referred to herein as “entities”) such as skills, titles, companies, and the like, as well as the properties and attributes of new content items (e.g., type, synonyms, etc.). Embodiments of the present disclosure can also identify the relationships between entities. The system may process social network data (e.g., member profile data, members connections and members' activities) to identify the relations between new entities and existing entities.

Referring again to method 200 in FIG. 2, embodiments of the present disclosure may retrieve (205) a user's online social network profile and analyze the content of the profile to identify one or more new content items (210). In some embodiments, the content of the profile is analyzed to identify attributes associated with the user associated with the profile. The system may also compare content items within the retrieved profile to content items stored in a database (e.g., database 128 in FIG. 1) to identify a new content item that is present in the retrieved profile, but not present in the database.

Embodiments of the present disclosure can identify new entities/content items in a variety of different categories and formats. Content items may include attributes associated with a member of the social network, a job or career field, titles (e.g., “software engineer,” “sales associate, etc.), skills (e.g., “C++ programming”), organizations (e.g., companies, educational institutions, etc.), geographical locations, and other attributes. These entities and the relationships among them may be used by embodiments of the present disclosure to enhance its recommender systems, search, monetization and consumer products, and business and consumer analytics, among other things.

Content items may be generated from a variety of different sources. For example, content items may include user-generated content from members, recruiters, advertisers, and company administrators. Such entities/content items may also be referred to as “organic entities.” Informational attributes for organic entities may be produced and maintained by users. Examples of such attributes include members, premium jobs, companies created by their administrators, etc.

Content items may also be supplied by, or retrieved from, outside sources such as web sites on the Internet. In a professional social network, the system can help identify new content items in a scalable manner as new members register, new jobs are posted, new companies, skills, and titles appear in member profiles and job descriptions.

Content items may also be automatically generated by the social networking system server or other system. The system may, for example, create new entities for which there is a substantial number of members that could be mapped to the new entity. In some embodiments, the system may analyze existing member profiles for new entity candidates and, utilizing external data sources and human validations to enrich candidate attributes, create new entities such as skills, titles, geographical locations, companies, certificates, etc., to which it can map members.

The system may utilize a variety of different algorithms and machine learning techniques to identify new content items (210). For example, in some embodiments, machine learning is applied to entity taxonomy construction, entity relationship inference, data representation for downstream data consumers, insight extraction from knowledge graphs, and interactive data acquisition from users to validate inferences and collect training data.

The system can generate (230) and display (235) a graph that visually represents new content items in relation to existing content items. Such graphs may be referred to herein as “knowledge graphs.” In some embodiments, the knowledge graph may be a dynamic graph where new entities are added to the graph and new relationships are formed continuously on a real-time or near-real-time basis. The graph may also be updated with new entities on a periodic basis (e.g., daily or weekly). Existing relationships within content items in the graph can also change. For example, the mapping from a member to her current title changes when she has a new job.

The taxonomy of a content item (i.e., the manner in which the content item is classified or categorized) may include a variety of different attributes. For example, in some embodiments an entity/content item taxonomy includes one or more identifiers (e.g., a definition, a name, synonyms in different languages, etc.) and other attributes of an entity.

Embodiments of the present disclosure can identify (210) potential candidates for new content items from member profiles, namely content items (such as terms associated with skills, jobs, etc.) that members entered into their profiles themselves. The system may retrieve (205) any number of member profiles to aggregate terms, phrases, and other content items within the profiles to obtain a list of new content item candidates sorted by frequency.

After one or more new content item candidates are initially identified, the system may filter a list of possible candidates and perform machine language-mapping or other processes to determine the validity of a new content item. In some embodiments, the system may utilize one or both of: a similarity mapping that generates a respective similarity score for a new content item, and a shared-word mapping that identifies one or more words in common between the new content item and existing content items (e.g., from other member profiles stored in a database).

In some embodiments, both mappings may be performed together as complements to each other. In some cases, for example, the similarity-based skill mapping may be more effective and cover more spelling variations. In other cases, the shared-word-based skill mapping may be more accurate and prevents false positives.

In one embodiment, the similarity mapping combines Levenstein similarity and Jaccard similarity by generating a similarity score that is the maximum of word-level Jaccard similarity and character-level Levenstein similarity. Potential new content items may be filtered based on the similarity score meeting or exceeding a predetermined threshold. For example, in one embodiment the similarity score may be between 0 and 1.0, and the system may only consider content items whose similarity score is greater than 0.5, while excluding content items whose similarity score is 0.5 or lower.

In some embodiments, the shared-word mapping process may compare the same or similar words between different profiles. In one embodiment, for example, any content item (e.g., a term for a skill) that contains a common word with the new content item candidate may be considered as a related content item.

In some embodiments, the entities/content items may be represented as nodes in the knowledge graph the system generates. The system may apply a variety of procedures to potential new entities in order to validate the new entities. In the case of user-generated organic entities, for example, such entities can have meaningless names, invalid or incomplete attributes, stale content, or no member mapped to them. The system may generate and apply rules to identify inaccurate or problematic organic entities.

The system may generate new entities having various attributes based on the contents of one or more member profiles. For example, the system may identify (210) a new content item in a member's profile, modify a data structure associated with the identified new content item to include various attributes, and store the new content item (e.g., embodied in its associated data structure) (215) in a database for future retrieval and use or comparison to other member profiles. The data structure may be of any suitable format (such as a list, linked list, table, array, tree, etc.) and may include any number of different fields associated with the new content item.

For example, in a professional online social network, new content items may be associated with skills listed by members in their profiles. Such new content items may include, among other things, a new skill, a new phrase associated with an existing skill, a new phrase associated with a new skill, and combinations thereof.

Identifying a new content item (210) may include identifying or determining a type or category for the new content item, and modifying the data structure associated with the new content item to include the identified type/category. Types/categories of content items that may be used in a professional online social network may include, for example, a type of job associated with a member (e.g., “software engineer”) as well as a type of skill associated with the member (e.g., “JAVA programming”).

A new content item may any number of additional attributes associated with it, such as name or other identifier, a definition, and a synonym for the identified type. In some embodiments, the identifier for a new entity candidate may include a phrase in a member profile, as well as job descriptions based on intuitive rules. Synonyms for the job type of “software engineer” might include, for example, “programmer” or “software developer.” in some embodiments, the identifier may be, or be based on, a word or phrase found within a member profile, and the word or phrase may be included in the data structure for the new entity verbatim or with modifications (such as translations, modification of tense, etc.).

Phrases can have different meanings in different contexts, and embodiments of the present disclosure may determine a particular meaning of a phrase by identifying one or more phrases in a profile, converting or representing each respective phrase as a vector, and applying a clustering algorithm to the vectors to identify ambiguous and unambiguous phrases. The system may then select from the unambiguous phrases for use in the “type” field of the data structure for the new entity or other attribute.

Similarly, multiple phrases can represent the same entity if they are synonyms of each other. The system may apply a clustering algorithm to the vectors of phrases to identify synonyms and duplicate phrases in order to “de-duplicate” the list of possible new entities. Similar techniques may also used to cluster entities if the taxonomy has a hierarchical structure.

In some embodiments, the selection of a phrase from a member profile may include translating the phrase from a first language (e.g., German) to a second language (e.g., English), and storing the phrase in the second language in the data structure. For example, the system may utilize machine translation models to automatically translate words and phrases in member profiles for use as attributes for new entities.

New content items may have attributes having relationships to one or more other content items stored in the database, while other attributes may be unrelated to other content items. For example, an entity may have the title “Software Engineer” in the title taxonomy. The title taxonomy may have a hierarchical structure, where similar titles such as “Programmer” and “Web Developer” are clustered into the same supertitle of “Software Developer,” and similar supertitles are clustered into the same function of “Engineering.” In another example, a company entity may have attributes that refer to other entities, such as members, skills, companies, and industries with identifiers in the corresponding taxonomies. The company entity may also have attributes such as a logo, revenue, and URL that do not refer to any other entity in any taxonomy. The former (related attributes) may be represented as edges in the knowledge graph generated by the system (discussed below) while the latter (unrelated attributes) may involve feature extraction from text, data ingestion from a search engine, data integration from external sources, and crowdsourcing-based methods, etc.

Entity relationships may include various mappings from members to other entities (e.g., the skills that a member has) which may in turn be used for various purposes, such as ad targeting, people search, recruiter search, feed, and business and consumer analytics, and the like. In a professional online social network, the mappings from jobs to other entities (e.g., the skills that a job requires) may be used in conjunction with job recommendations and job searches offered via the online social network.

Some entity relationships may be generated or defined by members. For example, a member may directly selects her company and a company administrator assigns an industry to the company. Such member-generated entity relationships may be referred to herein as “explicit” relationships. Additionally or alternatively, entity relationships may predicted by the system based on the content items within one or more member profiles. For example, when a member enters “linkedin_” as her company name in the profile, we predict her true company identifier is associated with “LinkedIn.” Such predicted entity relationships may be referred to as “inferred” relationships. In some cases, explicit relationships may not be accurate due to, for example, “member's mistake,” where members map themselves to an incorrect entity.

In some embodiments, the system may train a binary classifier for each kind of entity relationship. For example, a pair of entities belong to a given entity relationship in a binary manner (e.g., they belong or they do not) on the basis of a set of features. In some embodiments, the system may identify one or more member-defined attribute relationships from one or more member profiles, and apply the binary classifier process to determine the relationship an attribute's relationship to one or more content items based on the member-defined attribute relationships. In some embodiments, the system may randomly add noise as the negative training examples to train per-entity prediction models. To train a joint model covering entities in the long-tail of the distribution and to alleviate member selection errors, the system may also leverage crowdsourcing to generate additional labeled data.

Inferred relationships may also be recommended to members proactively to collect their feedback (e.g., via “accept,” “decline,” or “ignore”). Accepted relationships may automatically be designated as explicit relationships. A variety of different types of member feedback may further be collected as new training data, which can reinforce the next iteration of classifiers.

In some embodiments, entity attributes may have confidence scores computed by a machine learning model reflecting a level of accuracy for the respective attribute. Confidence scores predicted by the machine learning model(s) may be calibrated using a separate validation set, such that downstream applications can balance the tradeoff between accuracy and coverage by interpreting the confidence score as a probability.

Subsequent to identifying a new content item in a first member profile, the system may retrieve (205) a second member profile (or any number of additional member profiles) and compare the content items in the second profile to the new content item to determine a level of similarity (220) between the new content item and the existing content items in the second member profile. The level of similarity may be determined in any suitable manner, including by generating a similarity score as described above.

In some cases, the level of similarity between a new content item and the content items in the second member profile may be used to generate and transmit (225) an electronic communication to the second member identifying the new content item for possible inclusion in the second profile. In some embodiments, the communication is generated and transmitted in response to one or more content items in the second profile having a level of similarity that meets or exceeds a predetermined threshold. For example, if a new content item is identified for the skill of “C++ programming,” in the first member's profile, the system may transmit a message alerting the second member to the new content item in response to determining that the skill of “C programming” in the second member's profile meets or exceeds a predetermined level of similarity to “C++ programming.”

The electronic communication may be transmitted to a computing device of the second user over the Internet, such as via an email, text message, message within the online social network's messaging system, a message within the second member's feed, etc. The message may provide the second member (e.g., via a hyperlink) to include the new content item in the second member's profile, as well as to modify the new content item to customize it to the second member's specific attributes.

The system may generate (230) and display (235) a graph that visually represents the relationships between the new content item and other content items. An exemplary knowledge graph is shown in FIG. 5, with different content items (e.g., “learning,” “insights,” etc.) depicted as nodes in the graph and relationships between the content items as edges. The graph may depict content items having a relatively higher similarity to each other in relatively closer proximity to each other, and content items having a relatively lower similarity to each other in relatively farther proximity to each other. In graph in FIG. 5, for example, the entities “insights” and “learning” are depicted as having a relatively higher level of similarity to each other (and are located closer to each other), while “learning” and “jobs” have a relatively lower level of similarity to each other (and are located farther away from each other).

The graph may be displayed (235) on the display screens coupled to the computing devices of various members and other users of the social network. The graph (or underlying data) may also be transmitted to various users. For example, application teams may obtain the raw data used to generate the knowledge graph through a set of APIs that output the entity identifiers by taking either text or other entity identifiers as the input. Various classifier results may be represented in various structured formats, and served through Java libraries, REST APIs, Kafka (a high-throughput distributed messaging system) stream events, and RDFS files consistently with data version control. These data delivery mechanisms on the raw knowledge graph may be useful for displaying, indexing, and filtering entities in products.

In some embodiments, the system may embed the knowledge graph into a latent space such that the latent vector of an entity encompasses its semantics in multiple entity taxonomies and multiple entity relationships (classifiers) compactly. Such models may be used to, for example, predict a member's title latent vector based on simple arithmetic operations on the member's skill latent vectors. The model may further be used to infer the entity relationship from member to title. By optimizing the model for multiple objectives simultaneously, the system can learn latent representations more generically. Representing heterogeneous entities as vectors in the same latent space may provide a concise way for using the knowledge graph as a data source from which we can extract various kinds of features to feed relevance models, which may be particularly useful to relevance models, as it can significantly reduce the feature engineering work on the knowledge graph.

Additional knowledge can be inferred on top of the standardized knowledge graph, generating insights for business and consumer analytics. For example, by conducting OLAP to selectively aggregate graph data from different points of view, the system can generate real-time insights such as the number of members who have a given skill in a given location (supply), the number of job hires requiring a given skill in that same location (demand), the sophisticated skill gap after considering both supply and demand ends, and other information. The system can also constrain the data analytics into a certain time range for fetching retrospective insights. Among other things, such insights help leaders and sales persons make business decisions, and can help increase member engagement with the online social network. For example, insights may encourage members to add soft skills to their profiles or learn them in online courses offered by the social network.

FIG. 3 is a block diagram illustrating a mobile device 300, according to an exemplary embodiment. The mobile device 300 may be (or include) a client device 150 (in FIG. 1) or any other device operating in conjunction with embodiments of the present disclosure. The mobile device 300 may include a processor 302. The processor 302 may be any of a variety of different types of commercially available processors 302 suitable for mobile devices 300 (for example, an XScale architecture microprocessor, a microprocessor without interlocked pipeline stages (MIPS) architecture processor, or another type of processor 302). A memory 304, such as a random access memory (RAM), a flash memory, or other type of memory, is typically accessible to the processor 302. The memory 304 may be adapted to store an operating system (OS) 306, as well as application programs 308, such as a mobile location enabled application that may provide LBSs to a user. The processor 302 may be coupled, either directly or via appropriate intermediary hardware, to a display 310 and to one or more input/output (I/O) devices 312, such as a keypad, a touch panel sensor, a microphone, and the like. Similarly, in some embodiments, the processor 302 may be coupled to a transceiver 314 that interfaces with an antenna 316. The transceiver 314 may be configured to both transmit and receive cellular network signals, wireless data signals, or other types of signals via the antenna 316, depending on the nature of the mobile device 300. Further, in some configurations, a GPS receiver 318 may also make use of the antenna 316 to receive GPS signals.

Certain embodiments may be described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In exemplary embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some exemplary embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

Exemplary embodiments may be implemented in digital electronic circuitry, or in computer hardware, firmware, software, or in combinations of them. Exemplary embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In exemplary embodiments, operations may be performed by one or more programmable processors executing a computer program to perform functions by operating on input data and generating output. Method operations can also be performed by, and apparatus of exemplary embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice.

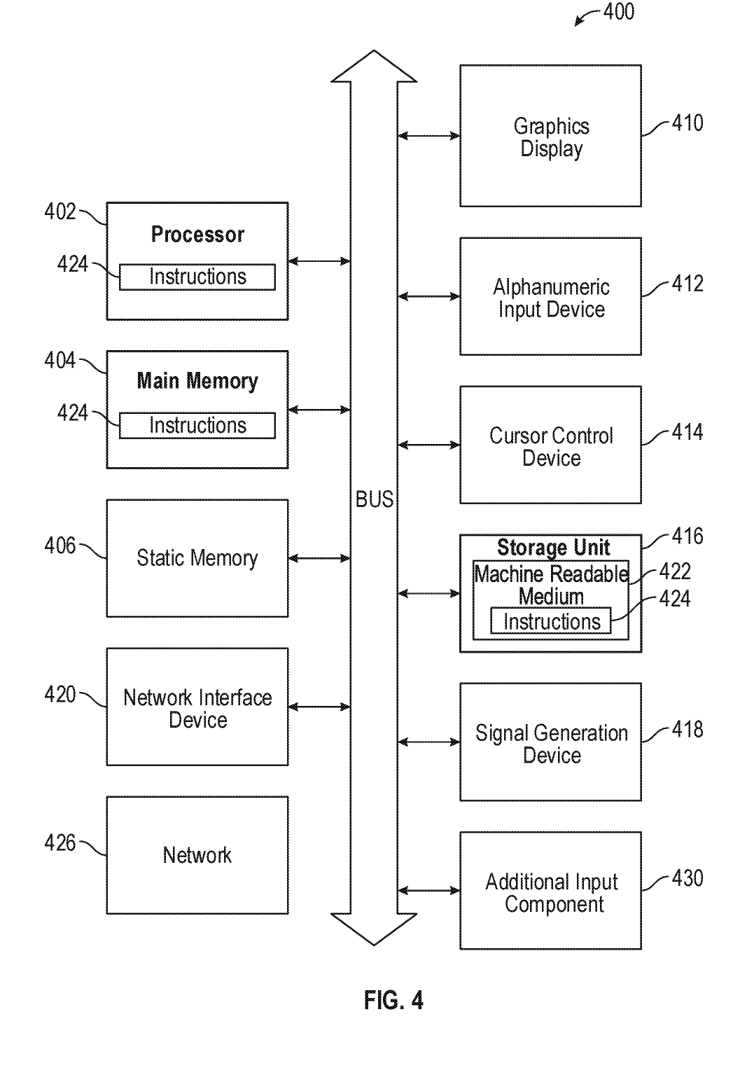

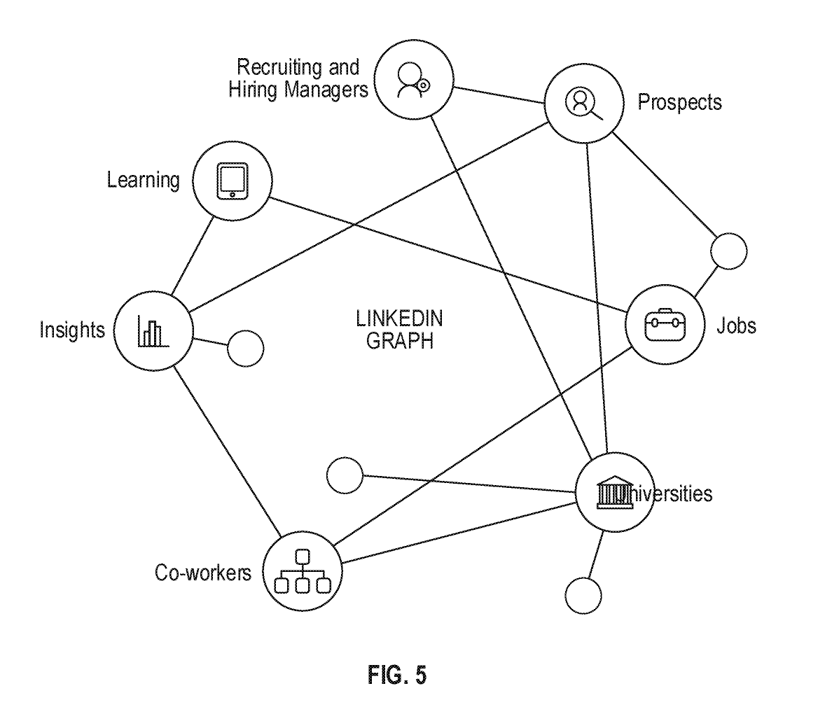

FIG. 4 is a block diagram illustrating components of a machine 400, according to some exemplary embodiments, able to read instructions 424 from a machine-readable medium 422 (e.g., a non-transitory machine-readable medium, a machine-readable storage medium, a computer-readable storage medium, or any suitable combination thereof) and perform any one or more of the methodologies discussed herein, in whole or in part. Specifically, FIG. 4 shows the machine 400 in the example form of a computer system within which the instructions 424 (e.g., software, a program, an application, an applet, or other executable code) for causing the machine 400 to perform any one or more of the methodologies discussed herein may be executed, in whole or in part.

In alternative embodiments, the machine 400 operates as a standalone device or may be connected (e.g., networked) to other machines. In a networked deployment, the machine 400 may operate in the capacity of a server machine or a client machine in a server-client network environment, or as a peer machine in a distributed (e.g., peer-to-peer) network environment. The machine 400 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 424, sequentially or otherwise, that specify actions to be taken by that machine. Further, while only a single machine is illustrated, the term “machine” shall also be taken to include any collection of machines that individually or jointly execute the instructions 424 to perform all or part of any one or more of the methodologies discussed herein.

The machine 400 includes a processor 402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 404, and a static memory 406, which are configured to communicate with each other via a bus 408. The processor 402 may contain microcircuits that are configurable, temporarily or permanently, by some or all of the instructions 424 such that the processor 402 is configurable to perform any one or more of the methodologies described herein, in whole or in part. For example, a set of one or more microcircuits of the processor 402 may be configurable to execute one or more modules (e.g., software modules) described herein.

The machine 400 may further include a graphics display 410 (e.g., a plasma display panel (PDP), a light emitting diode (LED) display, a liquid crystal display (LCD), a projector, a cathode ray tube (CRT), or any other display capable of displaying graphics or video). The machine 400 may also include an alphanumeric input device 412 (e.g., a keyboard or keypad), a cursor control device 414 (e.g., a mouse, a touchpad, a trackball, a joystick, a motion sensor, an eye tracking device, or other pointing instrument), a storage unit 416, an audio generation device 418 (e.g., a sound card, an amplifier, a speaker, a headphone jack, or any suitable combination thereof), and a network interface device 420.

The storage unit 416 includes the machine-readable medium 422 (e.g., a tangible and non-transitory machine-readable storage medium) on which are stored the instructions 424 embodying any one or more of the methodologies or functions described herein. The instructions 424 may also reside, completely or at least partially, within the main memory 404, within the processor 402 (e.g., within the processor's cache memory), or both, before or during execution thereof by the machine 400. Accordingly, the main memory 404 and the processor 402 may be considered machine-readable media (e.g., tangible and non-transitory machine-readable media). The instructions 424 may be transmitted or received over the network 426 via the network interface device 420. For example, the network interface device 420 may communicate the instructions 424 using any one or more transfer protocols (e.g., hypertext transfer protocol (HTTP)).

In some exemplary embodiments, the machine 400 may be a portable computing device, such as a smart phone or tablet computer, and have one or more additional input components 430 (e.g., sensors or gauges). Examples of such input components 430 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 422 is shown in an exemplary embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 424 for execution by the machine 400, such that the instructions 424, when executed by one or more processors of the machine 400 (e.g., processor 402), cause the machine 400 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various exemplary embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed. Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are legally entitled.

What is claimed is:

1. A method comprising:
retrieving, by a server computer system from a database, a first profile of a first member of an online social network;
comparing, by the server computer system, content items within the retrieved first profile to content items stored in a database to identify a new content item that is present in the first profile and not present in the database, wherein identifying the new content item includes performing one or more of: a similarity mapping that generates a respective similarity score for the new content item and each respective content item in the database, and a shared-word lapping that identifies one or more words in common between the new content item and the content items stored in the database;
storing, by the server computer system, the new content item in the database;
retrieving, by the server computer system from the database, a second profile of a second member of the online social network;
determining, by the server computer system, a level of similarity between a content item contained within the second profile and the new content item; and
transmitting, by the server computer system over the Internet, an electronic communication to a computing device of the second member identifying the new content item for possible inclusion in the second profile.

2. The method of claim 1, wherein the new content item comprises one or more of: a new skill, a new phrase associated with an existing skill, and a new phrase associated with a new skill.

3. The method of claim 1, wherein identifying the new content item includes identifying a type for the new content item and modifying a data structure associated with the new content item to include the identified type.

4. The method of claim 3, wherein identifying the new content item further includes modifying the data structure associated with the new content item to include one or more of: an identifier, a definition, and a synonym for the identified type.

5. The method of claim 4, wherein identifying the new content item further includes modifying the data structure associated with the new content item to include an identifier that is a phrase selected from the first profile.

6. The method of claim 5, wherein selecting the phrase from the first profile includes:
identifying a plurality of phrases within the first profile;
converting each respective phrase in the plurality of phrases into a respective vector to generate a plurality of vectors;
identifying ambiguous phrases and unambiguous phrases in the plurality of phrases by applying a clustering algorithm to the plurality of vectors; and
selecting the phrase from the first profile from among the unambiguous phrases.

7. The method of claim 6, wherein applying the clustering algorithm to the plurality of vectors includes identifying synonyms and duplicate phrases.

8. The method of claim 5, wherein selecting the phrase from the first profile includes translating the selected phrase from a first language to a second language, and including the phrase in the second language in the data structure.

9. The method of claim 1, wherein generating the similarity score for the new content item includes generating a similarity score that is a maximum of a world-level Jaccard similarity score and a character-level Levenstein similarity score.

10. The method of claim 9, wherein identifying the new content item includes selecting the new content item based on the generated similarity score meeting or exceeding a predetermined threshold.

11. The method of claim 1, wherein the new content item includes an attribute associated with one or more of: a member of the online social network, a job, a title, a skill, an organization, a geographical location, and an educational institution.

12. The method of claim 11, wherein the new content item includes a first attribute having a relationship to one or more content items stored in the database, and a second attribute that is unrelated to the content items stored in the database.

13. The method of claim 12, wherein the relationship to the one or more content items for the first attribute is defined by the first member.

14. The method of claim 12, wherein the relationship to the one or more content items for the first attribute is determined by the server computer system based on the content items within the first profile.

15. The method of claim 14, wherein determining the relationship to the one or more content items for the first attribute includes:
identifying a plurality of member-defined attribute relationships in a plurality of member profiles stored in the database;
applying a binary classifier process that determines the relationship to the one or more content items for the first attribute based on the plurality of member-defined attribute relationships.

16. The method of claim 11, wherein identifying the new content item includes generating a confidence score for the attribute reflecting a level of accuracy of the attribute.

17. The method of claim 1, further comprising generating, by the server computer system, a graph that visually represents the new content item in relation to the content items stored in the database.

18. The method of claim 17, wherein the graph depicts content items having a relatively higher similarity to each other in relatively closer proximity to each other, and content items having a relatively lower similarity to each other in relatively farther proximity to each other.

19. A system comprising:
a processor; and
memory coupled to the processor and storing instructions that, when executed by the processor, cause the system to perform operations comprising:
retrieving, from a database, a first profile of a first member of an online social network;
comparing content items within the retrieved first profile to content items stored in a database to identify a new content item that is present in the first profile and not present in the database, wherein identifying the new content item includes performing one or more of a similarity mapping that generates a respective similarity score for the new content item and each respective content item in the database, and a shared-word mapping that identifies one or more words in common between the new content item and the content items stored in the database;
storing the new content item in the database;
retrieving, from the database, a second profile of a second member of the online social network;
determining a level of similarity between a content item contained within the second profile and the new content item; and
transmitting, over the Internet, an electronic communication to a computing device of the second member identifying the new content item for possible inclusion in the second profile.

20. A tangible, non-transitory computer-readable medium storing instructions that, when executed by a server computer system, cause the server computer system to perform operations comprising:
retrieving, from a database, a first profile of a first member of an online social network;
comparing content items within the retrieved first profile to content items stored in a database to identify a new content item that is present in the first profile and not present in the database, wherein identifying the new content item includes performing one or more of a similarity mapping that generates a respective similarity score for the new content item and each respective content item in the database, and a shared-word mapping that identifies one or more words in common between the new content item and the content items stored in the database;
storing the new content item in the database;
retrieving, from the database, a second profile of a second member of the online social network;
determining a level of similarity between a content item contained within the second profile and the new content item; and
transmitting, over the Internet, an electronic communication to a computing device of the second member identifying the new content item for possible inclusion in the second profile.
